(19) United States
(12) Patent Application Publication
(10) Pub. No.: US 2008/0039515 A1
(43) Pub. Date: Feb. 14, 2008

(54) Arylpyrazoles And Methods Of Using Same For Control Of Insect Pests That Bore Into Trees

(75) Inventor: Donald M. Grosman, Lufkin, TX (US)

Correspondence Address: HUTCHISON LAW GROUP PLLC, PO BOX 31686, RALEIGH, NC, 27612, US

(73) Assignee: The Texas A&M University System, College Station, TX (US)

(21) Appl. No.: 11/791,899

(22) PCT Filed: Dec. 1, 2005
(86) PCT No.: PCT/US05/43350

§ 371 Date: Oct. 2, 2007

Related U.S. Application Data
(60) Provisional application No. 60/632,865, filed on Dec. 3, 2004.

(51) Int. Cl. A01N 43/56; A01P 7/04

(52) U.S. Cl. 514/407; 514/406

(57) ABSTRACT

Insecticidally effective agents are provided which reduce the damage caused to trees by a variety of insect pests which bore into trees. In particular, arylpyrazoles may be used to reduce the damage caused to trees by insect pests or to control insect pests, such as the southern pine beetle, by systemically treating trees with the arylpyrazoles.

### FIELD

The present invention is directed to methods and agents for reducing the extent of injury to trees caused by insect pests boring into the trees. Particularly, insecticidally effective agents with a systemic effect which reduces the extent of injury to trees caused by insect pests and methods of applying such agents for control of pests are provided.

### BACKGROUND

Insect pests which bore into trees causing damage or destruction of the trees are a common problem both for commercial growers of trees and for those responsible for trees in urban areas, recreational areas, stream side management zones, endangered species habitats and residential areas. When outbreaks of insect pests occur, millions of dollars in damage and destruction of trees may occur before the outbreak of insect pests is contained and the pest population controlled.

By way of example, bark beetles are common pests of conifers and some attack broadleaf trees. Several hundred species occur in the United States. More pine trees are believed to be killed by bark beetles than by any other group of insects. Bark beetles of the genera Dendroctonus, Ips, and Scolytus are some of the most destructive pests of forests and trees in the Northern Hemisphere. Five species of bark beetles are primarily responsible for most of the damage to pine trees, the southern pine beetle, Dendroctonus frontalis Zimm., the three southern Ips engraver beetles, Ips avulses Eich., Ips calligraphus Germ., and Ips grandicollis Eich., and the black turpentine beetle, Dendroctonus terebrans Oliv.

Bark beetles spend most of their lives beneath the bark of their host trees where adult beetles chew out tunnels, or galleries. The beetles lay eggs along the gallery sides. When the young larvae hatch from the eggs, the larvae bore away at the tree until fully developed, first transforming to pupae and then to adult beetles. At a certain time in the life cycle, the beetles chew through the bark and fly to attack other trees. The death of the tree results, inter alia, from girdling by the adult beetles in forming the galleries for laying the eggs, by larval feeding or tunneling and by fungi brought into the tunnels by the attacking beetles. A tree may be killed by the attacks of a single species of bark beetle or the tree may be attacked by two or more species of beetles.

Dendroctonus frontalis, the southern pine beetle, is a common problem insect pest of pine forests in the Southern United States. The favorite host trees for the southern pine beetle include the loblolly pine, Pinus taeda, and shortleaf pine, P. echinata, although all species of pine may be infected. The southern pine beetle is believed to kill more loblolly pine trees than any other mortality agent. Local and regional outbreaks of southern pine beetle cause severe economic losses on a nearly annual basis. According to the Southern Forest Insect Work Conference, an unprecedented outbreak during the period from 1999 to 2002 which extended across much of the southeastern United States was believed to cause over a billion dollars worth of losses due to southern pine beetle tree damage and mortality. The southern pine beetle affects the timber industry, and has a significant impact on recreation, water, and wildlife resources as well as residential property. For example, as the urban/wildland interface expands, residential trees become more at risk to southern pine beetle attack.

Protection of trees from boring insect pests has historically involved application of insecticides to the boles of trees, typically by hydraulic sprayers, or by broadcast aerial applications. Several products have been registered with the EPA for spray administration for the treatment of beetles, including benzene hexachloride, Lindane® (γ-benzene hexachloride), fenitrothion (O,O-dimethyl O-4-nitro-m-tolyl phosphorothioate, an organophosphate) and chiorpyrifos (O,O-diethyl O-(3,5,6-trichloro-2-pyridyl)phosphorothioate, an organophosphate, Dursban®). In 2003, bifenthrin ((2-methylbiphenyl-3-ylmethyl(Z)-(1RS,3RS)-3-(2-chloro-3,3,3-trifluoroprop-1-enyl)-2,2-dimethylcyclopropanecarboxylate, Onyx®) was registered by EPA for use against several species of bark beetles including the southern pine beetle and Ips engravers on ornamental plantings. However, even when available, insecticide spray applications have limitations. These treatments pose a high risk for worker exposure and drift and have limited selectivity, as well as often being expensive and time-consuming.

Several compounds have been considered as systemic insecticides for protection of individual trees or forested areas, including acephate (O, S-dimethyl acetylphosphoramidothioate), fenitrothion and a combination treatment of sodium N-methyldithiocarbamate (Vapam®) plus dimethyl sulfoxide (DMSO) applied to bark hacks, and dicrotophos, an organophosphate, ((E)-2-dimethylcarbamoyl-1-methylvinyl dimethyl phosphate, Bidrin®) which was applied by Mauget injectors™ to trees at the head of southern pine beetle infestations. Tree mortality was not prevented by any of the treatments; however, dicortophos was found to reduce both egg gallery length and subsequent brood production. Because dicortophos has a relatively high mammalian toxicity, it has not been registered for use by the general public. Oxydementon methyl applied by Mauget injectors™ is registered for use with the EPA against several Dendroctonus and Ips species of bark beetles, but it is not registered for southern pine beetle.

In view of the foregoing, additional agents and methods for the reduction of damage caused by insect pests such as beetles to trees are still needed. Thus, there is still a need in the art for systemically available insecticidally effective agents against boring insect pests which are substantially free of the disadvantages, defects and limitations of the insecticides disclosed in the art.

### SUMMARY

In accordance with the foregoing, there are provided by the embodiments of the present invention agents and methods for the control of insect pests which bore in trees and/or the reduction of injury caused by boring insect pests in trees.

In one embodiment, a method of reducing damage to a tree caused by insect pests boring into the tree is provided comprising systemically treating the tree with an insecticidally effective amount of an arylpyrazole agent.

In another embodiment, a method of controlling insect pests that bore into trees infested with or liable to be infested with insect pests is provided comprising systemically treating one or more of the trees with an arylpyrazole agent in an amount sufficient for effective control of the insect pests.

### BRIEF DESCRIPTION OF THE FIGURES

FIG. 1 is a photograph of a lesion surrounding an injection point on a PropD treated bolt as described in Example 1.

FIG. 2 is a photograph of a lesion surrounding an injection point on a PropA treated bolt from May as described in Example 1.

FIG. 3 is a photograph of a lesion surrounding an injection point on a PropA treated bolt from July as described in Example 1.

FIG. 4 is a photograph of an untreated bolt from three meters as described in Example 1. The black marks represent nuptial chambers.

FIG. 5 is a photograph of a PropA-treated bolt from three meters as described in Example 1. The black marks surrounded by the circles indicate unsuccessful attacks.

FIG. 6 is a photograph of a PropA-treated bolt with clear and colonized strips as described in Example 1.

FIG. 7 is a photograph of a fipronil-treated bolt with clear and colonized strips as described in Example 1.

FIG. 8 is a photograph of a Imidacloprid-treated bolt with clear and colonized strips as described in Example 1.

FIG. 9 is a photograph of the July bolt treatment groups, from left to right, imidacloprid, PropA, fipronil, PropD and check, as described in Example 1.

FIG. 10 is a photograph of a fading crown of a tree indicating tree mortality as described in Example 1.

FIG. 11 is a graphical representation of the effects of four agents on the number of Ips engravers beetles nuptial chambers with and without egg galleries on loblolly pine logs cut one, three, and five months after trunk injection as described in Example 1.

FIG. 12 is a graphical representation of the effects of four agents on the number of Ips engravers beetle egg galleries with and without brood on loblolly pine logs cut one, three, and five months after trunk injection as described in Example 1.

FIG. 13 is a graphical representation of the effects of four agents on the length of Ips engravers beetle egg galleries with and without brood on loblolly pine logs cut one, three and five months after trunk injection as described in Example 1.

FIG. 14 is graphical representation of the effects of four agents on area of phloem surface fed upon by wood borer (Ceranibycidae) larvae on loblolly pine logs cut one, three, and five months after trunk injection as described in Example 1.

FIG. 15 is a graphical representation of the percent survival and gain in survival of loblolly pine conelets treated as described in Example 2.

FIG. 16 is a graphical representation of the percent survival and gain in survival of loblolly pine cones treated as described in Example 2.

FIG. 17 is a graphical representation of the percent coneworms (Dyrictria spp.) damage and reduction in damage on second year loblolly pine cones treated as described in Example 2.

FIG. 18 is a graphical representation of the percent seed bugs (Tetyra sp. And Leptoglossus sp.) damage and reduction in damage on loblolly pine seed treated as described in Example 2.

FIG. 19 is a graphical representation of the percent combined losses from coneworms (Dyrictria spp.) and seed bug (Tetyra sp. And Leptoglossus sp.) damage and reduction in damage on loblolly pine cones and seed treated as described in Example 2.

### DETAILED DESCRIPTION

The present invention relates to methods and compositions for various uses, including the reduction of damage to trees caused by insect pests which bore into trees.

Definitions:

The phrase “reduction of damage caused by insect pests” or “reducing damage caused by insect pests” means reducing or limiting the extent of injury to a tree caused by one or more insect pests, particularly insect pests which bore into trees.

The phrase “amount sufficient for effective control of insect pests” means an amount capable of controlling the whole population of insect pests desired to be controlled. Typically, controlling the population of insect pests will involve removing or lessening the ability of the insect pests to cause harm and preferably will include the substantial eradication of the insect pests.

An “insect pest that bores into trees” includes any pest which attacks trees by boring into trees or any portion of a tree, including, but not limited to, the bark, terminal shoots, cones, conelets or seeds.

“Effective amount” or “insecticidally effective amount” means an amount having the ability to reduce injury caused by insect pests to a tree treated with the effective amount of insecticidally active material or agent.

“Treating systemically” or “systemic treatment” means the treatment is effected internally to the plant, for example, a tree, to be treated. Typically, the systemic treatment of a tree is conducted by placing the insecticidally effective agent inside the tree or portion thereof and/or placing the insecticidally effective agent such that the agent enters or is capable of entering an internal part of the tree or portion of the tree. Thus, the systemic treatment as defined herein involves having the insecticidally effective agent affect the tree or portion of tree to be treated from the inside of the tree or portion thereof. The insecticidally effective agent may enter the tree or be placed in such a way as to be capable of entering an internal part of a tree by any means which results in the insecticidally effective agent affecting the tree or portion of the tree from the inside thereof.

Insecticidal arylpyrazoles are known to those of skill in the art. In a preferred embodiment, the insecticidally active agent includes a 1-arylpyrazole with the following formula I:

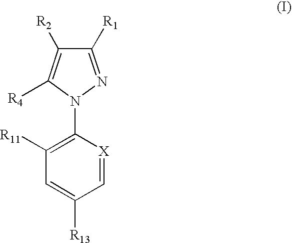

wherein: R₁ is CN or methyl;

R₂ is S(O)ₙR₃;

R₃ is alky or haloalkyl;

R₄ is H, halo, or a radical selected from —NR₅R₆, C(O)OR₇, —S(O)ₘR₇, alkyl, haloalkyl, —OR₈, or —N═C(R₉)(R₁₀);

R₅ and R₆ are independently H, alkyl, haloalkyl, —C(O)alkyl, or —S(O)ᵣCF₃; or R₅ and R₆ form together a divalent radical which may be interrupted by one or more heteroatoms;

R₇ is alkyl or haloalkyl;

R₈ is H, alkyl, or haloalkyl;

R₉ is H or alkyl;

R₁₀ is phenyl or heteroaryl, optionally substituted with one or more functional groups selected from hydroxy, halo, —O-alkyl, —S-alkyl, cyano, alkyl or combinations thereof;

X is N or the radical C—R₁₂;

R₁₁ and R₁₂ are, independently, H or halo;

R₁₃ is halo, haloalkyl, haloalkoxy, —S(O)_{q}CF₃ or —SF₅;

m, n, q, r are independently 0, 1 or 2;

provided that when R₁ is methyl, R₃ is haloalkyl, R₄ is NH₂, R₁₁ is Cl, R₁₃ is CF₃, and X is N.

The alkyl and alkoxy groups of the formula (I) are preferably lower alkyl and alkoxy groups, that is, radicals having one to four carbon atoms. The haloalkyl and haloalkoxy groups likewise preferably have one to four carbon atoms. The haloalkyl and haloalkoxy groups can bear one or more halogen atoms; preferred groups of this type include —CF₃ and —OCF₃.

Preferably, the 1-arylpyrazole has the following substitution:

R₁ is CN; and/or R₄ is —NR₅ R₆; and/or R₅ and R₆ are independently H, alkyl, haloalkyl, or —C(O)alkyl, and/or X is C—R₁₂; and/or R₁₃ is halo, haloalkyl, haloalkoxy, or —SF₅.

The most preferred 1-arylpyrazole is 5-amino-3-cyano-1-(2,6-dichloro-4-trifluoromethylphenyl)-4-trifluoromethylsulfinylpyrazole or fipronil.

The amount of insecticidally effective agent, preferably arylpyrazole, generally will be an amount which will provide the level of insecticidal activity required or desired. Typically, the amount of arylpyrazole is less than about one gram active ingredient (a.i.) of arylpyrazole for each inch of tree diameter. In one embodiment, the amount of arylpyrazole is about 0.05 grams to about 1 gram a.i. per inch of tree diameter. In a preferred embodiment, the arylpyrazole is applied in an amount of about 0.05 grams to about 0.5 grams a.i. per inch of tree diameter.

The arylpyrazole insecticide agent may be applied as the primary active agent or in the substantial absence of other active insecticidal agents. The arylpyrazole insecticide may also be applied in combination with other active insecticidal agents.

The amount of other insecticidal agents will be the amount desired for the effect sought.

The insecticidally active or effective agent or agents may be applied in a formulation which includes a number of other components for obtaining optimal delivery characteristics of the formulation depending on the desired method and form of application of the insecticidally active compound to the site of treatment. Such other components are known to those of skill in the art. By way of example, the insecticidally effective agent may be included in the form of a composition which is preferably in the form of a dispersion, an emulsion, or a solution, which optionally incorporates various wetting, dispersing, or emulsifying components. Typically, the composition will be an aqueous composition. The composition may be an emulsified or emulsifiable concentrate. In a preferred embodiment, an arylpyrazole, preferably fipronil, is delivered in an aqueous formulation to the site of treatment.

The insecticidally effective compositions may include as optional components additives such as adjuvants, carriers, wetting agents, surfactants, dispersants, dye-stuffs, or thixotropic agents. The compositions may also optionally include stabilizing substances, other insecticides, acaricides, plant nematocides, anthelmintics or anticoccidials, fungicides (agricultural or veterinary as appropriate e.g. benomyl, iprodione), bactericides, and various insect attractants, repellents or pheromones. These may be designed to improve potency, persistence, safety, uptake where desired, spectrum of insects controlled or to enable the composition to perform other useful functions in the same area treated.

The insecticidally effective arylpyrazole agents may be prepared according to methods known in the art, including those methods described in PCT Publication Nos. WO 87/03781, 93/06089, 94/21606, and EP 295,117, or alternatively, by another method from within the general experience of those skilled in the art competent in chemical synthesis.

The insecticidally effective agent may be delivered to a tree by any means effective for allowing the compound to enter the interior portion of the tree or a portion of the tree. By way of example, the insecticidally active agent may be delivered in a formulation by way of an injection apparatus such as the Arborjet™ or Sidewinder™ injection systems. Alternatively, the insecticidally active compound may be delivered to a tree through a naturally occurring or artificially created opening in the tree surface or bark of the tree using any device or applicator which results in the insecticidally active agent reaching the interior of the tree or a portion thereof. In a preferred embodiment, the active or effective agent is injected into the tree.

The arylpyrazoles of Formula I may be applied to trees which are infested with insect pests which bore into the tree or may be applied to one or more trees which are at risk of such infestation. Any or all tree or tree parts may be treated with the insecticidally effective agents.

The arylpyrazole insecticidally effective agents may be used to reduce injury to trees species which include conifers and hardwoods or deciduous species growing in any type of environment, including, but not limited to, on forestry sites, urban areas, suburban areas and transitional areas. The methods and compositions for controlling insect pests may be used, for example, in urban forests, recreational areas, stream side management zones, endangered species habitats and residential areas.

The insect pests which may be controlled with the arylpyrazole agents include any pests which bore into trees, such as those pests which attack trees by boring into trees or any portion of a tree, including, but not limited to, the bark, terminal shoots, cones, conelets or seeds. This includes, but is not limited to, bark beetles such as Dentroctonus spp. and Ips spp. and insect pests that attack cones or conelets such as coneworm and seed bug. Additionally, the arylpyrazole compositions may control or reduce damage caused by, by way of example, the following pests:
Southern pine beetle (Dendroctonus frontalis)
Western pine beetle (Dendroctonus breviconmis)
Ips wood borers
Black turpentine beetle (Dentroctonus terebrans)
Asian longhorn beetle (Anoplophora glabripennis)
Aspen root girdler (Agrilus horni)
Bronze birch borer (Agrilus anxius)
Brown spruce longhorn beetle (Tetrophium fuscum)
Citrus longhorned beetle (Anoplophora chinensis)
Common pine shoot beetle (Tomicus piniperda)
Emerald ash borer (Agrilusplanipennis)
European oak bark beetle (Scolytus intricatus)
European spruce bark beetle (Ips typographus)
Japanese cedar longhorned beetle (Callidiellum rufipenne)
Mediterranean pine engraver beetle (Orthotomicus erosus)
Mountain pine beetle (Dendroctonus ponderosae)
Pacific oak twig girdler (Agrilus angelicus)
Sugar maple borer (Glycobius speciosus)
Two-lined chestnut borer (Agrilus bilineatus)
Nantucket pine tip moth (Rhyacionia frustrana).

The insecticidally effective agent may be delivered to the site to be treated by any means, but will preferably be delivered in a manner effective to enable the insecticidally effective agent to reach the interior of the tree or portion of the tree intended to be treated. Typically, the insecticidally effective agent will be placed into the tree such that the agent may translocate throughout the tree. In one embodiment, an insecticidally effective arylpyrazole agent is injected into a tree through a cavity in the stem of the tree. The arylpyrazole agent then translocates throughout the tree. The presence of the insecticidally effective agent then disrupts the activity of the insect pests dwelling in or attacking the tree or attempting to attack the tree, resulting in a reduction in damage or extent of injury to the tree. In a preferred embodiment, the insecticidally effective agent is provided in an amount effective to control and/or eradicate the insect pests attacking the tree or attempting to attack the tree.

### EXAMPLES

The invention will be further explained by the following illustrative examples that are intended to be non-limiting.

### Example 1

A study was conducted to determine the efficacy of systemic insecticides for the protection of single trees against southern pine bark beetles. The study was designed to evaluate the efficacy of systemic injection of propA, imidacloprid, fipronil and propD in reducing attack success of pine bark beetles on loblolly pine, to evaluate the treatments applied using Arborjet's Tree IV™ pressurized injection system, and to determine the duration of treatment efficacy.

Study Sites: Two 20-year-old, recently thinned loblolly pine plantations were selected in Texas. Trees in one plantation were injected for use in a bolt study (Trial 1). Trees in ½ acre section of the second plantation were injected as part of a single-tree protection study (Trial 2). A staging area also was set up in the second plantation where bolts from the first plantation were exposed to bark beetles and wood borers.

Population Monitoring: A clear panel of acetate (10 cm wide by 25 cm long) was attached to the center of each bolt after deployment of bolts or 2 m high on standing trees after deployment of pheromone baits to monitor arrival of bark beetles. The top surface of each panel was coated entirely with Stikem Special® trapping compound (Michel and Pelton, Emeryville, Calif.). The traps were left in place for two weeks.

Treatments:
1) PropA (1.92% ai)—PropA, an avermectin derivative, was mixed 1:1 with methanol and applied at 18.6 ml solution per inch of tree diameter at breast height (DBH) (=0.2 g active per inch DBH).
2) Imidacloprid, a neonicotinoid, (IMA-jet, 5% ai, Arborjet, Inc.)—IMA-jet was mixed 1:3 with ADD-jet and applied at 16 ml solution per inch of tree DBH (=0.2 g active per inch DBH).
3) Fipronil (Regent 2.5EC, 28.2% ai, BASF)—Regent was mixed 1:2.8:7.5 with methanol and water and applied at 8 ml solution per inch of tree DBH (=0.2 g active per inch DBH).
4) PropD (10% ai)—PropD, a neonicotinoid, was mixed 1:3 with water and applied at 8 ml solution per inch of tree DBH (=0.2 g active per inch DBH).
5) Check (untreated).

Treatment Methods: Trial 1: Loblolly pine trees, Pinus taeda L., 15-20 cm (=6-9 inch) diameter at breast height (DBH), were selected in March of the study year in a 20-year-old pine stand in east Texas (Angelina County). Each treatment was injected into four cardinal points about 0.3 m above the ground on each of 15 trees in April (16^{th}-23^{rd}) using the Arborjet Tree IV™ microinfusion system (Arborjet, Inc. Woburn, Mass.).

After 1 (May 24), 3 (July 19) and 5 (September) months post-injection, 5 trees of each treatment were felled and two 1.5 m long bolts were removed from the 3 m and 8 m heights of the bole. Because southern pine beetle (SPB) populations were extremely low in east Texas during the study year, Ips engravers were used as alternative bark beetles for this study. The bolts were transported to a 20-year-old loblolly plantation that was recently thinned and contained fresh slash material. Each bolt was placed about 1 m apart on discarded, dry pine bolts to maximize surface area available for colonization as well as to discourage predation by ground and litter-inhabiting organisms. To facilitate timely bark beetle colonization, packets of bark beetle pheromones (racemic ipsdienol +lanerione combination, ipsenol or cis-verbenol; Phero Tech, Inc., Delta, BC, Canada) were attached separately to three 1 m stakes evenly spaced in the study area. Racemic ipsdienol and cis-verbenol were used with the second series of bolts deployed in July. The packets were removed after 2 weeks when signs of attacks (boring dust) were observed on most test bolts, signaling that naturally-produced pheromones were present.

Trial 2: Loblolly pine, 15-20 cm (=6-9 inch) DBH, also were selected in March of the study year in a recently thinned 20-year-old pine stand in east Texas. Each treatment (the same as those used in Trial 1) was injected into four cardinal points about 0.3 m above the ground on each of 6 trees in April (16^{th}-23^{rd}) using the Arborjet Tree IV™ system.

After 5 weeks post-injection (May 28), frills were cut with a hatchet into the sapwood between the injection points near the base of the tree. A cellulose. sponge was inserted into each cut and loaded with I0 ml of a 4:1 mix of sodium N-methyldithiocarbamate (MS) (Woodfume®; Osmose, Inc., Buffalo, N.Y.) plus dimethyl sulfoxide (DMSO) (Aldrich Chemical) (Roton 1987, Strom et al. 2004). This method reduces resin to near zero in 1-2 weeks. The intent was to stress the tree and make it susceptible to attack by bark beetles without killing it. Pheromone packets containing racemic ipsdienol+lanerione, ipsenol or cis-verbenol were attached (June 7) atop 3 m stakes evenly spaced in between and around the study trees to encourage attack by the three Ips engraver species. However, the initial results of the bolt trial suggested that encouraging Ips calligraphus (the largest and most common species) attack alone would allow for easier and more accurate measurements of beetle attack success. Thus, ipsdienol and cis-verbenol pheromone baits were deployed on all stakes on June 17^{th}. The baits were changed every 4 weeks.

Treatment Evaluation: Trial 1. The first and second series of bolts were retrieved 2.5 and 3 weeks, respectively, after deployment, after observing many cerambycid attacks on most of the bolts. In the laboratory, two 10×50 cm strips (total=1000 cm²) of bark were removed from each bolt. Several measurements were made relating to construction of nuptial chambers and egg galleries and development of brood:
1. Number of unsuccessful attacks—penetration to phloem, but no egg galleries.
2. Number of successful attacks—construction of nuptial chamber and at least one egg gallery extending from it.
3. Number and lengths of egg galleries with brood galleries radiating from them.
4. Number and lengths of egg galleries without brood galleries.
5. Cerambycid activity, estimated by overlaying a 100 cm² grid over a portion of each bark strip and counting the number of squares overlapping area where cerambycids had fed.

Treatment efficacy was determined by comparing Ips beetle attacks and egg gallery length and cerambycid feeding on treated and untreated bolts. The data were transformed by log₁₀(x+1) to satisfy criteria for normality and homoscedasticity (Zar 1984) and analyzed by GLM and the Fishers Protected LSD test using the Statview statistical program.

At the time of tree felling, a section of lower bole (˜60-80 cm) containing the injection points was taken from each injected tree. The bark was later removed around the injection points to determine if any damage had resulted from the installation of plugs and/or injection of chemicals. If damage was found, the length and width of any ‘lesions’ (discolored areas on the surface of the xylem) were measured.

Trial 2. Three weeks after pheromone deployment (June 28), each tree was evaluated by marking a 30 cm (1 ft) section of bole at a height of 3 m (10 ft). All visible Ips attacks and cerambycid egg niches were counted within the marked area. The number of trees with fading crowns also was recorded. Thereafter, the trees were evaluated weekly for crown fading. When mortality did occur, the trees were felled and two bolts taken and evaluated for attack success and gallery length as described in Trial 1. All remaining trees were felled 66 days (Aug. 9) after initial pheromone deployment when no additional trees had died for 2 weeks. Treatment efficacy was determined by comparing tree survival, beetle attacks and egg gallery length on treated and untreated bolts. As before, data were transformed and analyzed by GLM and the Fisher's Protected LSD test using the Statview statistical program.

Results: Trial 1: Arborjet's Tree IV™ system was successfully used to inject all chemical formulations. The installation of the system on the tree (drilling holes, installing plugs, pressurizing the system, and installing needles) usually took about 5 minutes when using 3 systems in tandem. Most injections were completed in just a few minutes. For the Prop A/methanol formulation, it was necessary to reduce the system pressure to 20-30 psi when injecting. Otherwise, at higher pressures (40-50 psi), the product flowed into the tree so quickly there was not enough time to install all 4 needles and obtain even distribution of the product among the injection points.

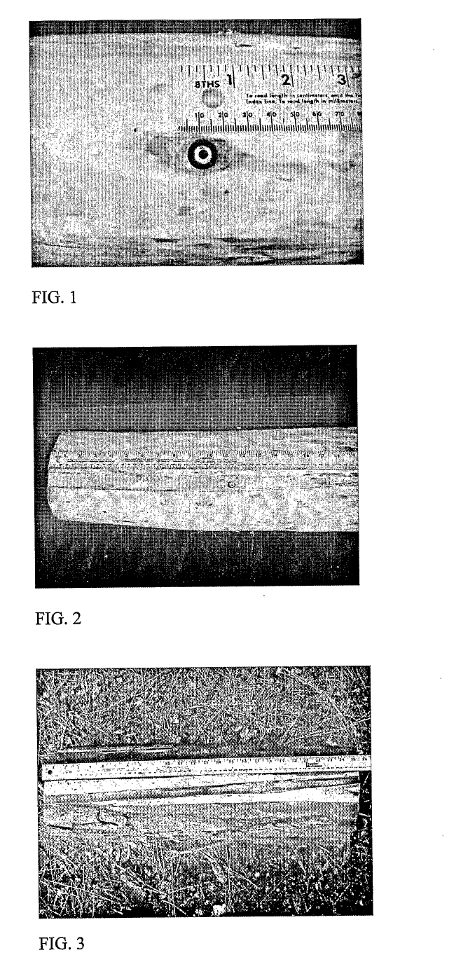

Evaluation of the phloem and xylem around the injection points for both series of bolts revealed lesions of various length and widths at nearly all injection points. Trees injected with PropD or fipronil had lesions that extended only a short distance from the injection points (Table 1, FIG. 1). Imidacloprid-induced lesions were nearly twice as long but far shorter than those resulting from injection of Prop A (FIG. 2-3).

Signs of beetle attack (boring dust) were visible on several bolts in just a few days after the bolts had been moved to the staging area and the pheromone baits deployed.

| | | May (1 month | | July (3 months | | |
|---|---|---|---|---|---|---|
| | | post-injection) | | post-injection) | | |
| | | Length | Width | Length | Width | |
| Treatment * | n | (cm) | (cm) | (cm) | (cm) | |
| PropD | 20 | 3.6 a ** | 1.6 a | 5.5 a | 1.5 | ab |
| PropA | 20 | 47.3+ c | 2.3 b | 63.5+ b | 1.8 | b |
| Fip | 20 | 4.1 a | 1.5 a | 4.1 a | 1.4 | ab |
| Imid | 20 | 7.3 b | 1.7 a | 6.1 a | 1.3 | a |

* Fip = Fipronil, Imid = Imidacloprid
** Means followed by the same letter in each column are not significantly different at the 5% level based on Fisher's Protected LSD
+Lesion usually extended well past the end the log.

After 2 weeks, several Ips attacks and numerous cerambycid egg niches were evident on the bark surface of most bolts. There was concern that if cerambycid larvae were allowed to develop too long, their feeding activity would obscure or obliterate the Ips galleries. Thus, the bolts were retrieved from the field on June 10^{th} and August 9^{th} and stored temporarily in a TFS seedling cooler (˜45° F.) to slow cerambycid development until the bolts could be evaluated.

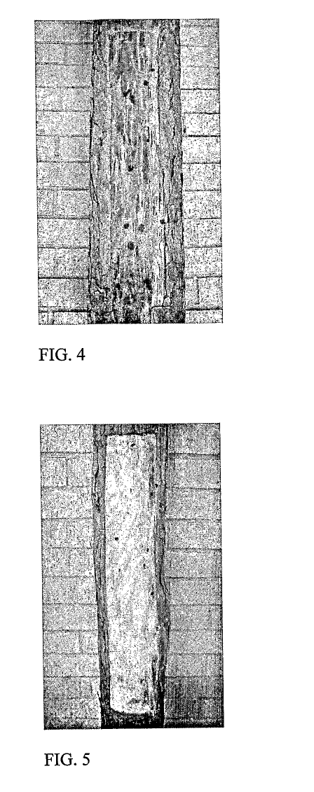

Ips Attack Success—The number of Ips engraver beetles landing on individual bolts varied considerably but did not differ among the treatments for either height or series (Table 2). In contrast, the total number of attacks (nuptial chambers constructed) by male beetles often differed among the treatments. The number of attacks was not necessarily reflective of the success of the attack. In May, untreated bolts were heavily attacked (FIG. 4). In July, significantly fewer attacks were found on check bolts compared to most of the other treatments. For both series, nearly all nuptial chambers were successfully constructed on untreated bolts—with at least one egg gallery radiating from each nuptial chamber.

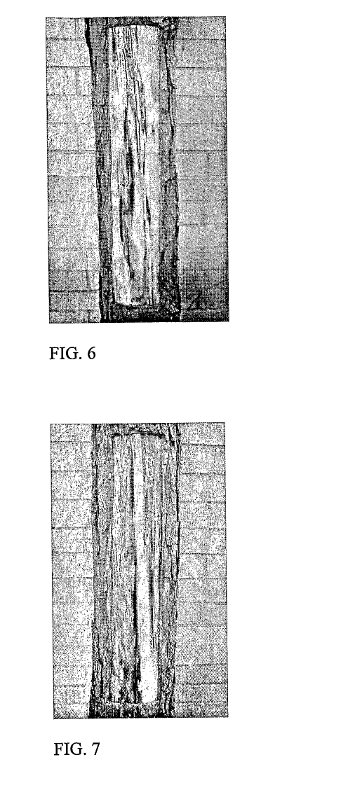

For PropA-treated bolts evaluated in May, most attacks were unsuccessful at the 3 m (79%) and 8 m (69%) heights (FIG. 5) and all (100%) attacks were unsuccessful at both heights in July (FIG. 9). It appeared that nearly all attacks were aborted or the beetles died as soon as they penetrated into the phloem region. There were a few successful Ips attacks on one tree out of five in May, but these attacks were far fewer in number compared to check trees and were restricted to narrow strips on the bolt (FIG. 6).

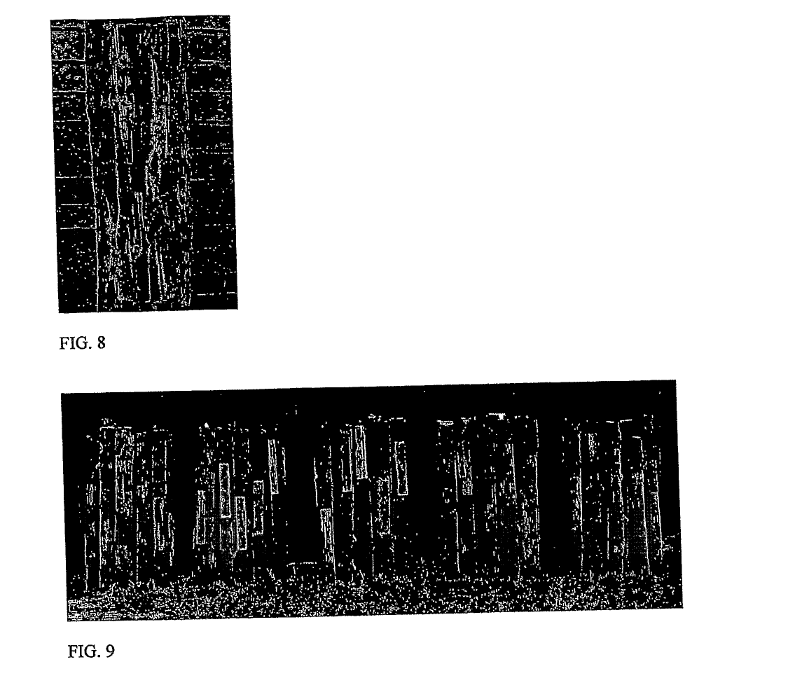

In May, a number of trees treated with fipronil (FIG. 7) and imidacloprid (FIG. 8) showed patches or strips of reduced attack success. But, the uncolonized strips were usually narrower. This indicates that fipronil and imidacloprid had not dispersed laterally around the trees to the same extent as PropA. Nearly half (49%) of the attacks on fipronil-treated trees were unsuccessful (no egg galleries) on bolts from 3 m. This treatment did not reduce attack success at the 8 m height. Both treatments, fipronil in particular, were more effective by July in preventing successful attacks on 3 m (78%) and 8 m (91%) bolts. The clear uncolonized area extended nearly all the way around the fipronil-treated tree bole, while the clean areas were still narrow or nonexistent on imidacloprid bolts (FIG. 9). In May, PropA sharply reduced the total number (81% and 96%) and length (94% and 99%) of egg galleries at 3 m and 8 m, respectively, compared to check trees (Table 3). No other treatment reduced the total number of galleries. However, when the number and length of galleries with brood were compared to galleries without brood, all injection treatments reduced the proportion of galleries with brood and their lengths relative to the checks. Fipronil was second only to PropA in reducing the number and length of egg galleries with brood. In July, PropA completely prevented the construction of egg galleries in all bolts. Fipronil was nearly equal in its efficacy. Although a few egg galleries were constructed, almost none had developing brood. Imidacloprid and PropD did reduce the proportion of galleries with brood and their lengths relative to the checks but the proportions were all greater than 50% of the totals.

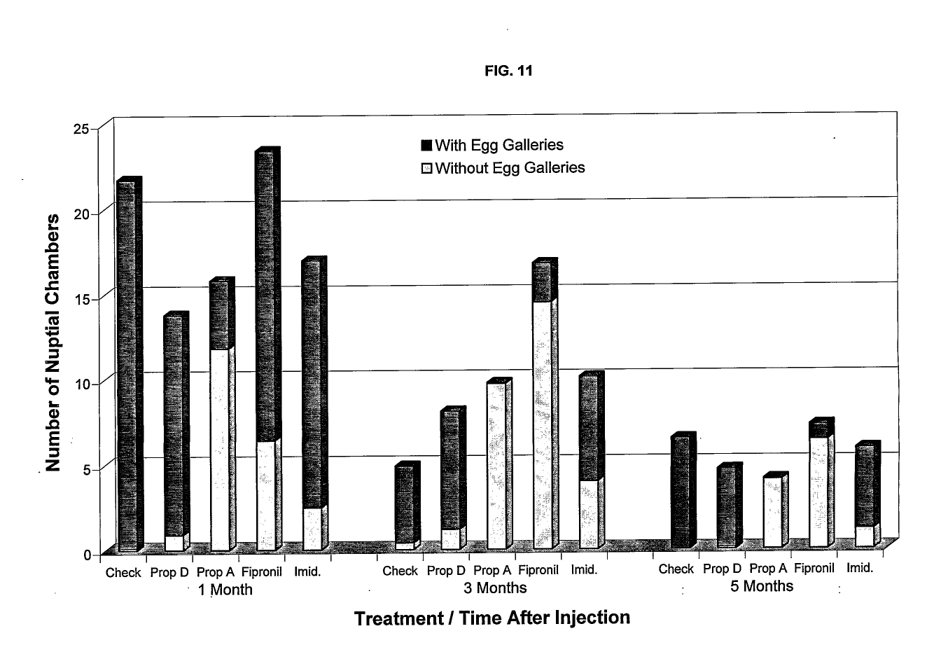

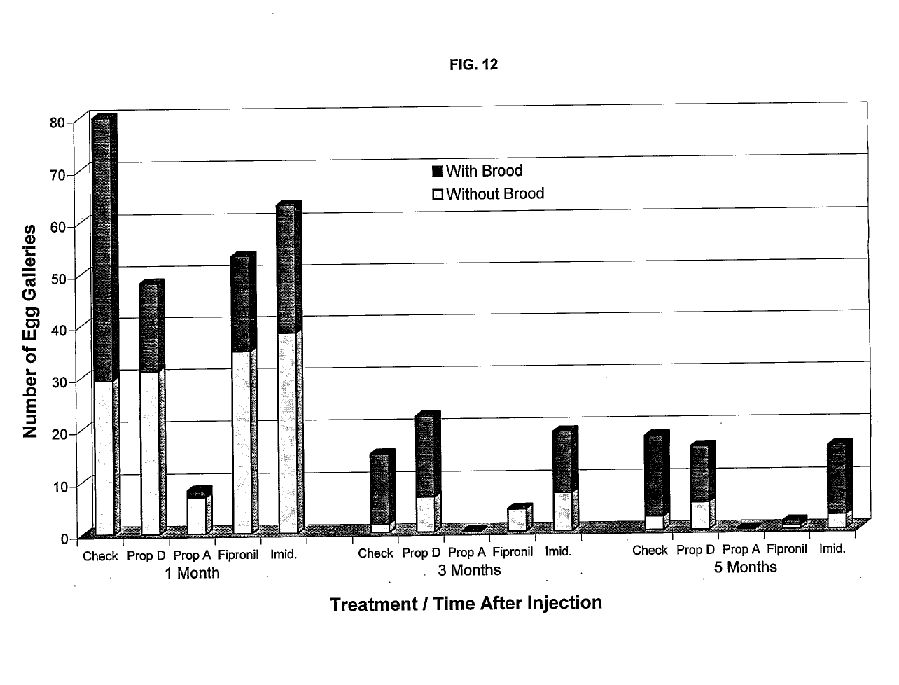

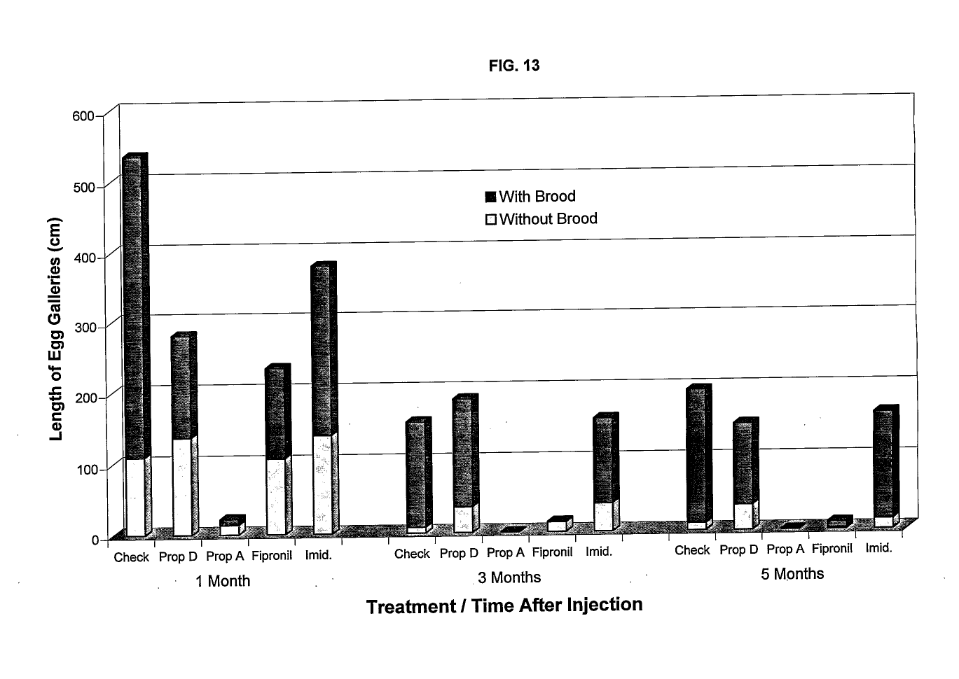

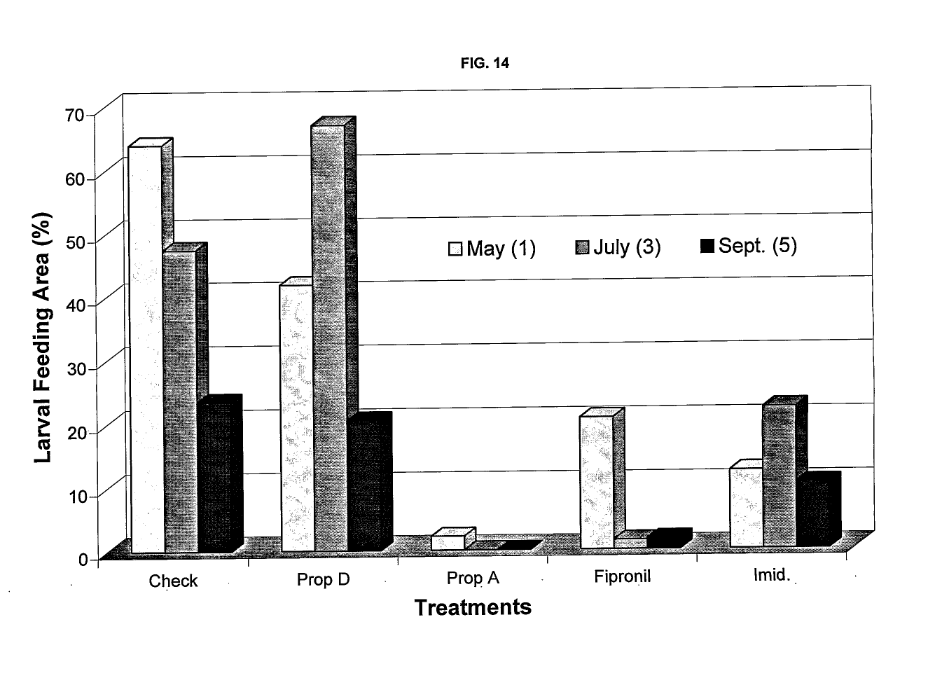

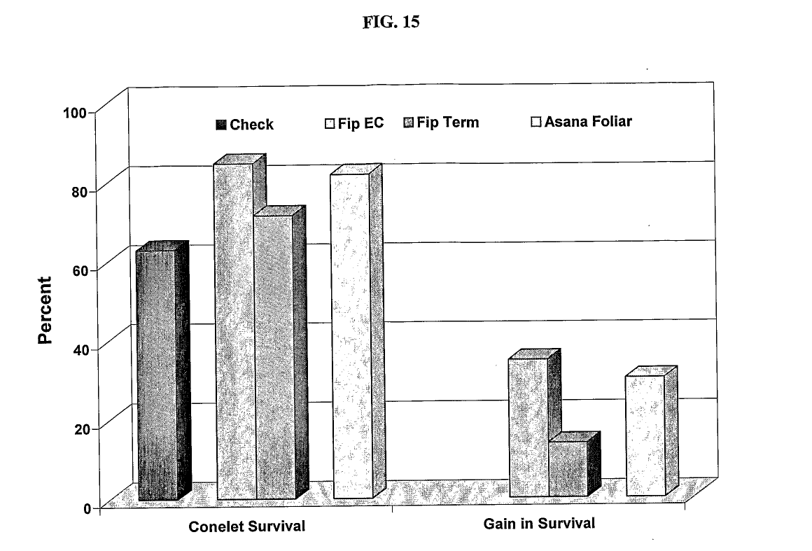

Cerambycid Larval Feeding—In May, cerambycid larvae were found to have fed upon 30% and 34% of the phloem area on untreated bolts taken from 3 m and 8 m, respectively, during the 3 weeks period between tree felling and bolt evaluation (Table 3). Very little larval feeding or development was found on PropA-treated bolts. Overall, this treatment reduced feeding damage by 93% and 100% on bolts from 3 m and 8 m, respectively. Fipronil reduced feeding by 82% on bolts at 3 m, and by 55% at 8 m. Imidacloprid reduced feeding by 98% on bolts at 8 m, and by 61% at 3 m. PropD had no apparent effect at 3 m, but reduced feeding by 60% at 8 m. In July, cerambycid larvae fed upon 23% and 25% of-the phloem area on untreated bolts taken from 3 m and 8 m, respectively (Table 3). In contrast, no larval feeding or development was found on PropA-treated bolts from 3 m and only 2% of the fipronil bolt was fed upon from the same height. No colonization occurred at 8 m for either treatment. Imidacloprid and PropD did not significantly reduce the area fed upon by borer larvae compared to the check. The results at 5 months are also shown in Table 3. Additional results in graphical form are shown in FIGS. 11-14.

TABLE 2
Effects of four systemic insecticides on attraction, attack success and gallery construction of Ips
engravers beetles on loblolly pine logs cut one, three and five months after trunk injection.

| | | | | | Nuptial Chambers Without | | | Nuptial Chambers With | | | | |
|---|---|---|---|---|---|---|---|---|---|---|---|---|
| | | | | | Egg Galleries | | | Egg Galleries | | | | |
| Evaluation | Bolt | | Mean # of Ips | | | | % of | | | % of | | |
| Period | Height | Trt * | caught/trap | | No. | | Total | No. | | Total | Total | |
| 1 Month | 3 m | Prop D | 4.8 | a | 0.6 | a ** | 3.9 | 14.8 | b | 96.1 | 15.4 | a |
| Post- | | Prop A | 3.8 | a | 14.6 | c | 78.5 | 4.0 | a | 21.5 | 18.6 | a |
| Injection | | Fip | 4.0 | a | 10.2 | c | 48.6 | 10.8 | b | 51.4 | 21.0 | a |
| (May) | | Imid | 5.6 | a | 2.0 | b | 11.0 | 16.2 | b | 89.0 | 18.2 | a |
| | | Chk | 6.8 | a | 0.0 | a | 0.0 | 16.0 | b | 100.0 | 16.0 | a |
| | 8 m | Prop D | 2.8 | a | 1.2 | ab | 9.8 | 11.0 | b | 90.2 | 12.2 | a |
| | | Prop A | 4.8 | a | 9.0 | c | 69.2 | 4.0 | a | 30.8 | 13.0 | ab |
| | | Fip | 3.6 | a | 2.6 | b | 10.1 | 23.2 | b | 89.9 | 25.8 | bc |
| | | Imid | 3.8 | a | 3.0 | bc | 19.0 | 12.8 | b | 81.0 | 15.8 | abc |
| | | Chk | 5.0 | a | 0.2 | a | 0.7 | 27.2 | b | 99.3 | 27.4 | c |
| 3 Months | 3 m | Prop D | 5.4 | a | 1.0 | a | 17.9 | 4.6 | c | 82.1 | 5.6 | a |
| Post- | | Prop A | 1.8 | a | 11.0 | b | 100.0 | 0.0 | a | 0.0 | 11.0 | ab |
| Injection | | Fip | 4.8 | a | 9.8 | b | 77.8 | 2.8 | b | 22.2 | 12.6 | b |
| (July) | | Imid | 2.6 | a | 4.2 | a | 38.9 | 6.6 | c | 61.1 | 10.8 | ab |
| | | Chk | 2.4 | a | 0.8 | a | 13.3 | 5.2 | c | 86.7 | 6.0 | a |
| | 8 m | Prop D | 2.2 | a | 1.4 | ab | 13.2 | 9.2 | c | 86.8 | 10.6 | bc |
| | | Prop A | 3.4 | a | 8.4 | c | 100.0 | 0.0 | a | 0.0 | 8.4 | b |
| | | Fip | 4.6 | a | 19.2 | c | 91.4 | 1.8 | b | 8.6 | 21.0 | c |
| | | Imid | 2.0 | a | 3.8 | b | 40.4 | 5.6 | bc | 59.6 | 9.4 | b |
| | | Chk | 2.8 | a | 0.0 | a | 0.0 | 3.8 | b | 100.0 | 3.8 | a |
| 5 Months | 3 m | Prop D | 2.6 | a | 0.0 | a | 0.0 | 4.2 | b | 100.0 | 4.2 | ab |
| Post- | | Prop A | 1.2 | a | 3.8 | b | 100.0 | 0.0 | a | 0.0 | 3.8 | a |
| Injection | | Fip | 1.2 | a | 7.4 | c | 92.5 | 0.6 | a | 7.5 | 8.0 | b |
| (Sept.) | | Imid | 1.6 | a | 0.2 | a | 4.3 | 4.4 | b | 95.7 | 4.6 | ab |
| | | Chk | 1.6 | a | 0.0 | a | 0.0 | 5.2 | b | 100.0 | 5.2 | ab |
| | 8 m | Prop D | 0.6 | a | 0.2 | a | 3.8 | 5.0 | b | 96.2 | 5.2 | a |
| | | Prop A | 0.4 | a | 4.4 | b | 100.0 | 0.0 | a | 0.0 | 4.4 | a |
| | | Fip | 0.8 | a | 5.4 | b | 81.8 | 1.2 | a | 18.2 | 6.6 | a |
| | | Imid | 1.5 | ab | 2.2 | b | 30.6 | 5.0 | b | 69.4 | 7.2 | a |
| | | Chk | 2.2 | b | 0.0 | a | 0.0 | 7.8 | b | 100.0 | 7.8 | a |

* Prop D = Proprietary D, Prop A = Proprietary A, Fip = Fipronil, Imid = Imidacloprid
** Means followed by the same letter in each column are not significantly different at the 5% level based on Fisher's Protected LSD

TABLE 3
Effects of four systemic insecticides on gallery construction of Ips engravers beetles and cerambycid
larval development in loblolly pine logs cut one, three and five months after trunk injection.

| | | | Number of Egg Galleries | | | | | | | | Length of Egg Galleries | | | | | | | | | |
|---|---|---|---|---|---|---|---|---|---|---|---|---|---|---|---|---|---|---|---|---|
| | | | Without Brood | | | With Brood | | | | | Without Brood | | | With Brood | | | | | | |
| Evaluation | Bolt | | | | % of | | | % of | | | | | % of | | | % of | | | Cerambycid | |
| Period | Ht | Trt * | No. | | Total | No. | | Total | Total | | cm | | Total | cm | | Total | Total | | Feeding Area | |
| 1 Month | 3 m | Prop D | 33.2 | b | 61.5 | 20.8 | c | 38.5 | 54.0 | b | 146.0 | b | 44.3 | 183.4 | c | 55.7 | 329.4 | bc | 56.5 | c |
| Post- | | Prop A | 10.0 | a | 80.6 | 2.4 | a | 19.4 | 12.4 | a | 15.5 | a | 50.5 | 15.2 | a | 49.5 | 30.7 | a | 4.4 | a |
| Injection | | Fip | 23.6 | b | 70.2 | 10.0 | b | 29.8 | 33.6 | b | 64.4 | b | 47.7 | 70.6 | b | 52.3 | 135.0 | b | 10.8 | ab |
| (May) | | Imid | 35.2 | b | 54.0 | 30.0 | c | 46.0 | 65.2 | b | 159.0 | b | 36.0 | 283.2 | c | 64.0 | 442.2 | c | 23.6 | bc |
| | | Chk | 29.0 | b | 44.1 | 36.8 | c | 55.9 | 65.8 | b | 114.8 | b | 23.8 | 368.4 | c | 76.2 | 483.2 | c | 59.8 | c |
| | 8 m | Prop D | 29.2 | b | 68.9 | 13.2 | b | 31.1 | 42.4 | b | 128.0 | b | 55.4 | 103.2 | b | 44.6 | 231.2 | b | 27.2 | b |
| | | Prop A | 4.0 | a | 95.2 | 0.2 | a | 4.8 | 4.2 | a | 12.3 | a | 91.1 | 1.2 | a | 8.9 | 13.5 | a | 0.0 | a |
| | | Fip | 46.2 | b | 63.3 | 26.8 | c | 36.7 | 73.0 | b | 149.6 | b | 45.0 | 183.2 | b | 55.0 | 332.8 | b | 30.8 | b |
| | | Imid | 29.6 | b | 60.4 | 19.4 | bc | 39.6 | 49.0 | b | 118.8 | b | 37.6 | 197.0 | b | 62.4 | 315.8 | b | 1.2 | a |
| | | Chk | 30.0 | b | 31.7 | 64.6 | d | 68.3 | 94.6 | b | 104.4 | b | 17.7 | 483.8 | c | 82.3 | 588.2 | b | 68.3 | c |
| 3 Months | 3 m | Prop D | 3.4 | ab | 20.0 | 13.6 | b | 80.0 | 17.0 | c | 12.4 | ab | 7.6 | 150.4 | b | 92.4 | 162.8 | c | 66.2 | c |
| Post- | | Prop A | 0.0 | a | | 0.0 | a | | 0.0 | a | 0.0 | a | | 0.0 | a | | 0.0 | a | 0.0 | a |
| Injection | | Fip | 5.6 | b | 100.0 | 0.0 | a | 0.0 | 5.6 | b | 19.4 | b | 100.0 | 0.0 | a | 0.0 | 19.4 | b | 3.0 | a |
| (May) | | Imid | 6.4 | b | 31.1 | 14.2 | b | 68.9 | 20.6 | c | 36.0 | b | 19.2 | 151.4 | b | 80.8 | 187.4 | c | 28.0 | b |
| | | Chk | 2.2 | ab | 12.9 | 14.8 | b | 87.1 | 17.0 | c | 14.4 | b | 9.2 | 142.0 | b | 90.8 | 156.4 | c | 46.0 | bc |
| | 8 m | Prop D | 10.4 | c | 37.7 | 17.2 | c | 62.3 | 27.6 | c | 59.8 | c | 28.2 | 152.2 | bc | 71.8 | 212.0 | c | 67.8 | b |
| | | Prop A | 0.0 | a | | 0.0 | a | | 0.0 | a | 0.0 | a | | 0.0 | a | | 0.0 | a | 0.0 | a |
| | | Fip | 2.8 | bc | 93.3 | 0.2 | a | 6.7 | 3.0 | b | 8.2 | b | 89.1 | 1.0 | a | 10.9 | 9.2 | b | 0.0 | a |
| | | Imid | 8.2 | c | 47.1 | 9.2 | b | 52.9 | 17.4 | c | 42.6 | bc | 32.8 | 87.4 | b | 67.2 | 130.0 | c | 16.6 | b |
| | | Chk | 1.0 | ab | 7.7 | 12.0 | bc | 92.3 | 13.0 | c | 2.4 | ab | 1.5 | 153.6 | c | 98.5 | 156.0 | c | 49.0 | b |
| 5 Months | 3 m | Prop D | 2.6 | bc | 21.7 | 9.4 | b | 78.3 | 12.0 | c | 12.8 | c | 11.2 | 101.6 | b | 88.8 | 114.4 | c | 33.8 | b |
| Post- | | Prop A | 0.0 | a | | 0.0 | a | | 0.0 | a | 0.0 | a | | 0.0 | a | | 0.0 | a | 0.0 | a |
| Injection | | Fip | 0.6 | ab | 60.0 | 0.4 | a | 40.0 | 1.0 | b | 2.4 | ab | 41.4 | 3.4 | a | 58.6 | 5.8 | b | 3.4 | ab |
| (Sept.) | | Imid | 1.4 | abc | 10.6 | 11.8 | b | 89.4 | 13.2 | c | 9.2 | bc | 5.6 | 154.2 | b | 94.4 | 163.4 | c | 11.8 | b |
| | | Chk | 2.8 | c | 17.7 | 13.0 | b | 82.3 | 15.8 | c | 9.8 | c | 6.1 | 150.6 | b | 93.9 | 160.4 | c | 18.6 | c |
| | 8 m | Prop D | 7.8 | d | 39.4 | 12.0 | b | 60.6 | 19.8 | c | 57.8 | c | 31.3 | 126.8 | b | 68.7 | 184.6 | c | 7.2 | b |
| | | Prop A | 0.0 | a | | 0.0 | a | | 0.0 | a | 0.0 | a | | 0.0 | a | | 0.0 | a | 0.0 | a |
| | | Fip | 0.8 | ab | 40.0 | 1.2 | a | 60.0 | 2.0 | b | 2.2 | a | 14.5 | 13.0 | a | 85.5 | 15.2 | b | 0.0 | a |
| | | Imid | 3.4 | c | 18.9 | 14.6 | b | 81.1 | 18.0 | c | 19.6 | b | 11.9 | 144.8 | b | 88.1 | 164.4 | c | 9.0 | b |
| | | Chk | 2.4 | bc | 11.9 | 17.8 | b | 88.1 | 20.2 | c | 10.8 | b | 4.6 | 223.4 | b | 95.4 | 234.2 | c | 28.4 | b |

* Prop D = Proprietary D, Prop A = Proprietary A, Fip = Fipronil, Imid = Imidacloprid
** Means followed by the same letter in each column are not significantly different at the 5% level based on Fisher's Protected LSD

Trial 2: Although the study area had adequate rainfall to maintain general tree health, the Vapam/DMSO treatment had the desired effect of stressing the trees. Resin weeping down the bark surface was the most visible sign of stress and this occurred on nearly 40% of study trees. The treatments did not differ in proportion of trees with this stress symptom. Five of the six check trees showed signs of bark beetle attack (pitch tubes and boring dust) 2 weeks after the Vapam/DMSO treatment was administered. All study trees were evaluated about 4 weeks after the Vapam/DMSO treatment (=24 days after initial pheromone deployment).

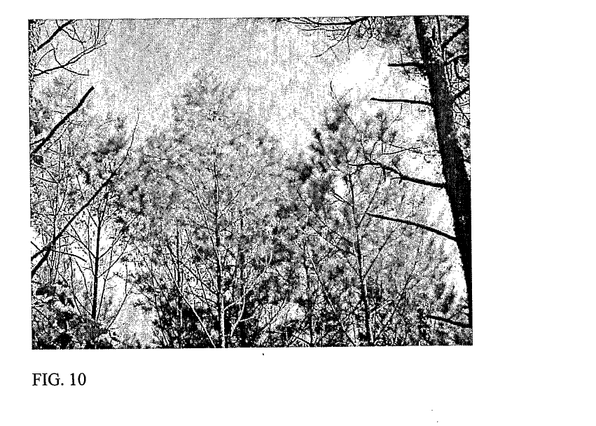

All checks and imidacloprid-treated trees were heavily attacked by Ips and most had two or more cerambycid egg niches at 3 m (Table 4). In contrast, PropA- and fipronil-treated trees had significantly fewer Ips attacks at the same height. Of the few Ips attacks that were found on these trees, nearly all appeared to have been unsuccessful based on the fact that the pitch tubes at the entrance holes were dry and brittle. There were no differences among the treatments in the number of cerambycid egg niches. There were differences among the treatments in the proportion of trees with early signs of fading crowns (yellowing needles) (Table 5, FIG. 10). None of the PropA- and fipronil-treated trees had fading crowns; whereas, half (3 of 6) of the imidacloprid-treated trees were fading. Two check trees and one PropD-treated tree also exhibited fading crowns.

The study was discontinued after 66 days when no additional trees had faded in 20 days (Table 5). In the end, all (100%) of the imidacloprid-treated and 5 of 6 (83%) of each of the check and PropD-treated trees had died due to bark beetle attack. In

TABLE 4
Effects of four systemic insecticides on arrival on and protection
of standing loblolly pine by Ips engraver beetles and

| | | Number of Attacks/0.3 m bole | | |
|---|---|---|---|---|
| | Mean # of Ips | section at 3 m after 24 days | | |
| Treatment * | caught/trap | | Ips | Cerambycid |

| | | | | | |
|---|---|---|---|---|---|
| PropD | 8.7 | b ** | 6.2 | b | 4.5 a |
| PropA | 1.2 | a | 0.5 | a | 0.8 a |
| Fip | 5.2 | ab | 1.3 | a | 1.3 a |
| Imid | 8.5 | b | 12.7 | c | 4.7 a |
| Chk | 6.5 | b | 14.7 | c | 4.3 a |

* Fip = Fipronil, Imid = Imidacloprid
** Means followed by the same letter in each column are not significantly different at the 5% level based on Fisher's Protected LSD

TABLE 5
Effects of four systemic insecticides on visible signs of mortality
on standing loblolly pine after pheromone bait deployment.

| | Pct of Trees w/Fading Crowns After: | | | | | | | | | | | | | |
|---|---|---|---|---|---|---|---|---|---|---|---|---|---|---|
| Treatment * | 24 days | | 32 days | | 39 days | | 46 days | | 52 days | | 59 days | | 66 days | |
| PropD | 16.7 | ab | 66.7 | b | 83.3 | b | 83.3 | b | 83.3 | b | 83.3 | b | 83.3 | b |
| PropA | 0.0 | a | 0.0 | a | 0.0 | a | 0.0 | a | 0.0 | a | 0.0 | a | 0.0 | a |
| Fip | 0.0 | a | 0.0 | a | 0.0 | a | 0.0 | a | 0.0 | a | 0.0 | a | 0.0 | a |
| Imid | 50.0 | b | 83.3 | b | 83.3 | b | 83.3 | b | 100.0 | b | 100.0 | b | 100.0 | b |
| Chk | 33.3 | ab | 66.7 | b | 83.3 | b | 83.3 | b | 83.3 | b | 83.3 | b | 83.3 | b |

* Fip = Fipronil, Imid = Imidacloprid
** Means followed by the same letter in each column are not significantly different at the 5% level based on Fisher's Protected LSD

contrast, all PropA- and fipronil-treated trees survived. Evaluation of cut bolts showed that all trees had been attacked, but the PropA-treated bolts had significantly fewer attacks at both heights than the check (Table 6). All attacks that did occur were completely unsuccessful. One fipronil tree was partially colonized and may have ultimately succumbed to attack if the trial had been allowed to continue for a few more weeks. Even if this tree had eventually died, this would have left 83% of the treatment trees still alive and indicates that fipronil is a good protection option. Both PropA- and fipronil-treated bolts had significantly fewer and shorter egg galleries with and without brood compared to all other treatments (Table 7).

Conclusions: All chemical formulations were quickly injected into the study trees for both trials using the Arborjet Tree IV™ system. However, evaluation of the phloem and xylem surrounding the injection points revealed that the PropA solution caused the development of long vertical lesions.

In both trials, PropA was effective in preventing successful attacks by Ips bark beetles and cerambycids one and three months after injection. On the bolts, at least,

TABLE 6
Effects of four systemic insecticides on attraction, attack success
and gallery construction of Ips engraver beetles on loblolly pine
logs cut after tree mortality or the end of the trial.

| | | Nuptial Chambers Without | | | Nuptial Chambers With | | | | |
|---|---|---|---|---|---|---|---|---|---|
| | | Egg Galleries | | | Egg Galleries | | | | |
| Bolt | | | | % of | | | % of | Total Nuptial | |
| Height | Trt * | No. | | Total | No. | | Total | Chambers | |
| 3 m | PropD | 6.8 | b | 38.7 | 10.8 | b | 61.3 | 17.7 | c |
| | PropA | 3.0 | ab | 100.0 | 0.0 | a | 0.0 | 3.0 | a |
| | Fip | 5.0 | b | 81.1 | 1.2 | a | 18.9 | 6.2 | ab |
| | Imid | 0.2 | a | 2.0 | 8.0 | b | 98.0 | 8.2 | bc |
| | Chk | 3.2 | ab | 32.8 | 6.5 | b | 67.2 | 9.7 | bc |
| 8 m | PropD | 0.3 | a | 8.0 | 3.8 | bc | 92.0 | 4.2 | ab |
| | PropA | 1.3 | ab | 100.0 | 0.0 | a | 0.0 | 1.3 | a |
| | Fip | 1.5 | ab | 33.3 | 3.0 | ab | 66.7 | 4.5 | ab |
| | Imid | 2.7 | b | 21.3 | 9.8 | c | 78.7 | 12.5 | b |
| | Chk | 0.8 | ab | 12.2 | 6.0 | bc | 87.8 | 6.8 | b |

* Fip = Fipronil, Imid = Imidacloprid
** Means followed by the same letter in each column are not significantly different at the 5% level based on Fisher's Protected LSD

TABLE 7
Effects of four systemic insecticides on gallery construction of Ips engraver beetles and cerambycid
larval development in loblolly pine logs cut after tree mortality or at the end of the trial.

| | | Number of Egg Galleries | | | | | | | | Length of Egg Galleries | | | | | | | | | |
|---|---|---|---|---|---|---|---|---|---|---|---|---|---|---|---|---|---|---|---|
| | | Without Brood | | | With Brood | | | | | Without Brood | | | With Brood | | | | | Borer Feeding | |
| Bolt | | | | % of | | | % of | | | | | % of | | | % of | | | Area (% of | |
| Ht | Trt * | No. | | Total | No. | | Total | Total | | cm | | Total | cm | | Total | Total | | Total Area) | |
| 3 m | PropD | 18.3 | b | 61.1 | 11.7 | b | 38.9 | 30.0 | b | 71.2 | b | 45.2 | 86.3 | b | 54.8 | 157.5 | b | 9.8 | b |
| | PropA | 0.0 | a | | 0.0 | a | | 0.0 | a | 0.0 | a | | 0.0 | a | | 0.0 | a | 0.0 | a |
| | Fip | 1.0 | a | 85.7 | 0.2 | a | 14.3 | 1.2 | a | 3.5 | a | 58.3 | 2.5 | a | 41.7 | 6.0 | a | 0.0 | a |
| | Imid | 27.2 | b | 71.2 | 11.0 | b | 28.8 | 38.2 | b | 179.8 | c | 59.6 | 121.7 | b | 40.4 | 301.5 | b | 5.7 | b |
| | Chk | 17.2 | b | 59.5 | 11.7 | b | 40.5 | 28.8 | b | 108.3 | bc | 48.0 | 117.2 | b | 52.0 | 225.5 | b | 3.6 | b |
| 8 m | PropD | 11.3 | bc | 42.2 | 15.5 | b | 57.8 | 26.8 | b | 83.7 | b | 36.4 | 146.5 | b | 63.6 | 230.2 | b | 11.7 | c |
| | PropA | 0.0 | a | | 0.0 | a | | 0.0 | a | 0.0 | a | | 0.0 | a | | 0.0 | a | 0.0 | a |
| | Fip | 7.2 | ab | 93.5 | 0.5 | a | 6.5 | 7.7 | a | 20.2 | a | 89.0 | 2.5 | a | 11.0 | 22.7 | a | 0.0 | a |
| | Imid | 19.0 | c | 57.3 | 14.2 | b | 42.7 | 33.2 | b | 102.0 | b | 46.9 | 115.5 | b | 53.1 | 217.5 | b | 0.5 | ab |
| | Chk | 18.5 | c | 40.5 | 27.2 | b | 59.5 | 45.7 | b | 91.0 | b | 30.8 | 204.0 | c | 69.2 | 295.0 | b | 6.2 | bc |

* Fip = Fipronil, Imid = Imidacloprid
** Means followed by the same letter in each column are not significantly different at the 5% level based on Fisher's Protected LSD

those male Ips that initiated attacks were either deterred or killed upon penetration into the phloem layer and exposure to the active ingredient. It is surmised that any pheromone production by males as they burrow through the bark was halted prematurely. Without these pheromones, very few, if any, females were attracted to the host material or entered the nuptial chamber to mate and begin construction of egg galleries. Even when females did arrive and began construction of galleries, the galleries were very short and brood did not developed beyond the initial larval instars. Assuming that this scenario also occurred in the standing trees, the halting of pheromone production upon male contact with the phloem layer also halted the attraction of additional males, thus preventing the mass attack of the host tree.

Fipronil also showed moderate activity against bark beetles and cerambycids in the bolt trial. However, the diffusion of fipronil throughout the tree appeared to be incomplete 4 weeks after injection as indicated by the strips of clean, uncolonized phloem (FIG. 7). With additional time (3 months), the chemical had dispersed enough in the tree to provide full protection from beetle attack as indicated by the final results from the standing trees and second series of bolts.

Imidacloprid and PropD, both neonicotinoids, so far do not appear to have any marked effect against bark beetles. Imidacloprid effectively reduced the amount of cerambycid feeding one month post-injection, but it was only marginally effective after three months in both the bolt and standing tree trials.

### Example 2

A systemic insecticide injection study was undertaken to evaluate the efficacy of systemic injections of fipronil in reducing seed crop losses in loblolly pine seed orchards, evaluate the treatments applied using the systemic tree injection tubes (STIT), Arborjet™, and Sidewinder™ pressurized injection systems, and to determine the duration of treatment efficacy.

The study site was a 20 acre orchard block containing 11 year old drought hardy loblolly pine in Jasper County, Texas. The insecticides tested included fipronil (Termidor®) and fipronil EC, an emulsified concentrate formulation of fipronil. The design of the study was a randomized complete block with clones as blocks. Four treatments X 6-8 clones=30 ramets were used for the study.

Study trees were selected and measured for diameter at breast height (DBH) to determine volume of insecticide to be injected. For application using Arborjet™, at least four holes, ⅜ inch in diameter and 8 cm (3 inch) deep, were drilled about 1 meter high at cardinal points on the tree bole. Arborplugs were installed in each hole. The Arborjet™ system was used to inject a predetermined amount of product into each hole. Due to drought conditions, usually one or more plugs failed, or leaked, on each treatment tree. Either additional injection points were installed on a treatment tree until the full amount was injected into each tree or injections were delayed until early in the morning on later dates.

For application with the Sidewinder™, at least four holes, 9 mm ( 7/16 inch) diameter and 8 cm (three inches) deep, were drilled-about one meter high at cardinal points on the tree bole. The Sidewinder™ drill was installed in the hole and a predetermined amount of product was pumped into the tree. Due to drought conditions, injections often failed or leaked. Either new injection points were installed until the full amount was injected into each tree or injections were delayed until early in the morning on later dates.

The treatments were as follows:
1. 10 ml of 4% fipronil EC per inch tree DBH by Arborjet™ or Sidewinder™ injectors (N=8);
2. 10 ml of 4% fipronil (Termidor®) per inch tree DBH by Arborjet™ or Sidewinder™ injectors (N=6);
3. Asana® XL (foliar standard, (S)-cyano(3-phenoxyphenyl)methyl(S)-4-chloro-alpha-(1-methylethyl)-benzeneacetate) applied by hydraulic sprayer to foliage five times per year at 9.6 ounces/100 gallons at 5-week intervals. (N=8);
4. Check (untreated) (N=8).

The data collected included conelet and cone survival, Dioryctria attacks and seed bug damage. For conelet and cone survival data, six to ten branches were tagged per sample tree including a minimum of 50 conelets and 50 cones. The conelets and cones were reevaluated for damage and survival again about five months later.

For obtaining data regarding Dioryctria attacks, all cones in the study trees that could be reached by a bucket truck were picked about a month after the second evaluation of the conelets and cones. The cones were categorized as small dead, large dead, green infested, with other insect or disease damage, or healthy.

The seed bug damage was evaluated by picking 10 healthy cones at random from all healthy cones collected from each ramet. The seeds were extracted and radiographed with x-ray. The seeds were categorized as full seed, empty, seed bug-damaged, second year abort, seedworm-damaged, and other damage.

Results

The study trees averaged 30.4 cm in diameter. Due to drought conditions, the insecticides to be tested were difficult to inject using both the Arborjet™ and the Sidewinder™ systems, so multiple visits early in the morning were required to treat all the study trees. The Arborjet™ and the Sidewinder™ systems averaged 10 injection points and 8 injections points, respectively.

The orchard block containing the treatment trees had not been sprayed since establishment, suggesting that pressure from coneworms and seed bugs would be moderate to high. This was confirmed for coneworms by 31% damage on check cones examined during the study as shown in Table 9. Relatively low numbers of both leaf-footed and shieldbacked pine seed bugs were observed in the trees during the study. This was reflected by the 21% damage to seed from check trees as shown in Table 10. Seedworm damage to seed from check trees was considered insignificant during the study (1% or less).

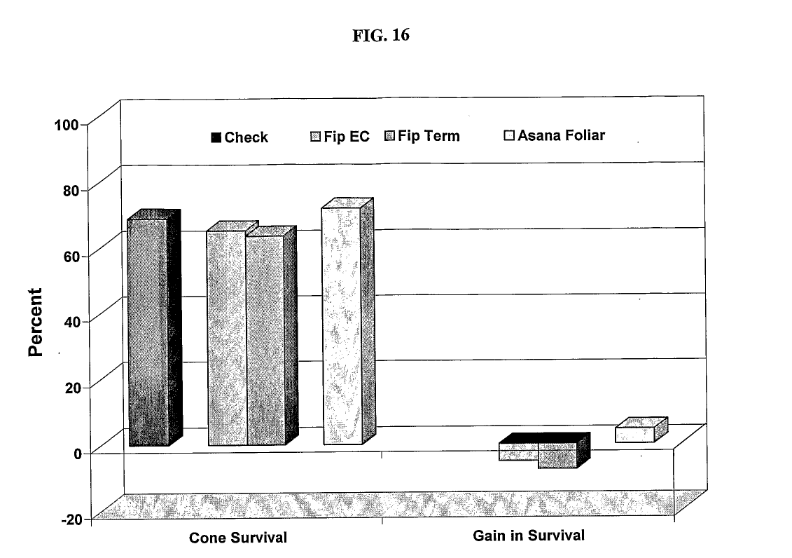

Cones and conelets on tagged branches were examined in the spring and the fall, about 5-6 months apart. The fipronil EC and foliar treatments significantly improved survival of conelets, but none of the treatments improved survival of cones compared to check trees as shown in Table 8 and FIGS. 15 and 16. Overall, fipronil EC provided the best protection of conelets, improving survival by 35% over that of the check as shown in Table 8.

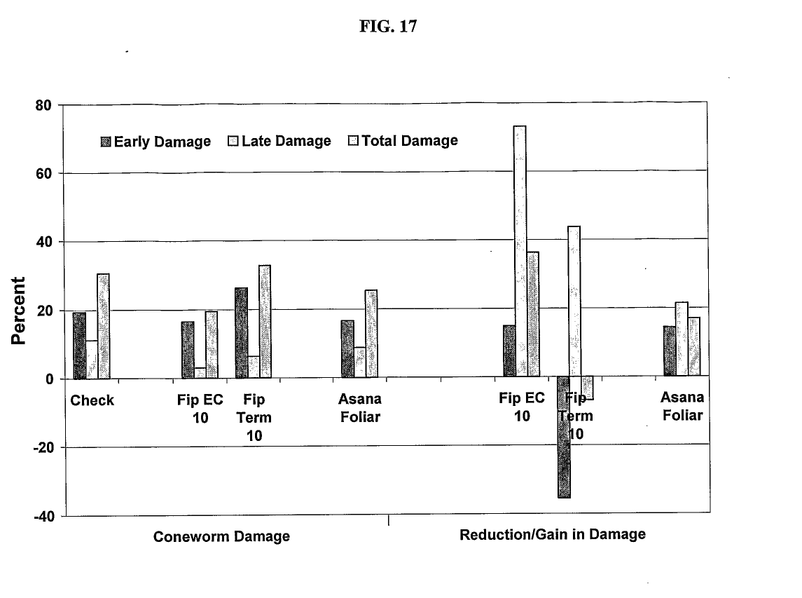

Neither fipronil injection treatments significantly reduced early coneworm damage compared to the check as shown in Table 9 and FIG. 17. However, the efficacy of both formulations improved markedly later in the season. The fipronil EC formulation showed the greatest improvement, reducing late season coneworm damage by 73%. Termidorm reduced damage by 44% compared to the check trees.

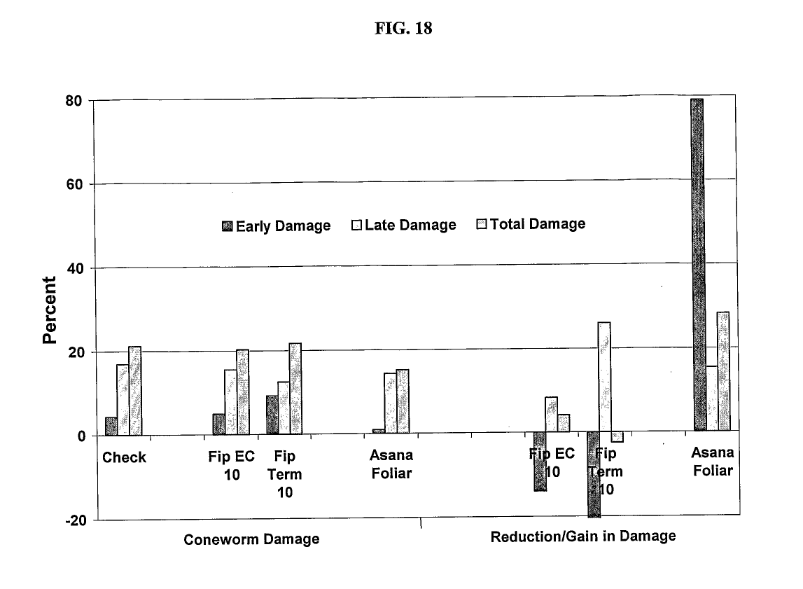

Seed bug damage levels (21%) were lower in the test year in the check cones compared to previous years as shown in Table 10. The higher level of damage late in the growing season compared to earlier in the year again indicates that the shieldbacked pine seed bug had a much greater impact on seed production at this orchard than did the leaffooted pine seed bug. None of the treatments, including Asana XL, significantly reduced total seed bug damage as shown in FIG. 18, nor did these treatments increase the number of full seeds per cone compared to the check trees. However, there was a similar trend in improved treatment efficacy for both fipronil treatments late in the season as observed for coneworms.

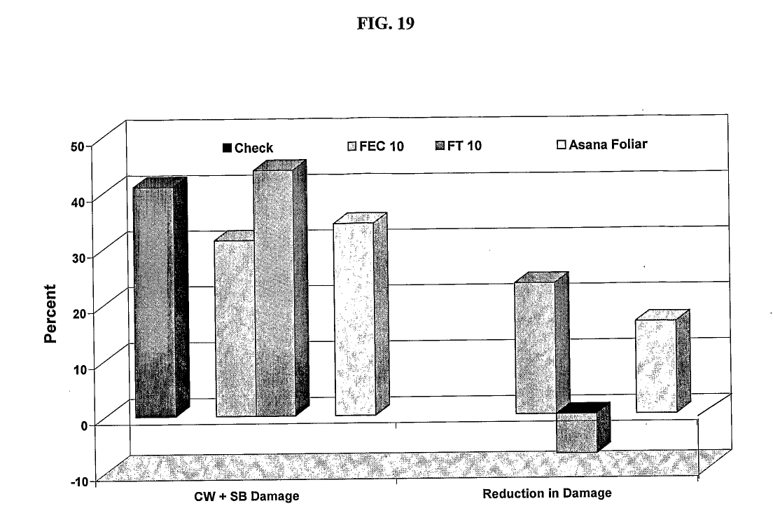

An estimate of the combined losses due to two primary insect pest groups, coneworms and seed bugs, was calculated by adding the proportion of coneworm-damaged cones to the proportion of all seed in healthy cones damaged by seed-bug. In this study, it is conservatively estimated that during the study year, coneworms and seed bugs in combination reduced the potential seed crops of the check trees by 41% as shown in Table 11. The fipronil EC treatments were most effective in reducing overall insect damage, giving a 24% reduction in damage as shown in FIG. 19.

The late season improvement in efficacy in the fipronil insecticides may indicate a time period required for the fipronil to be translocated to the target sites or cones in the canopy. Some of the delay may have been due to the drought conditions prevalent at the time of injection in the test year.

TABLE 8
Mean percentages (±SE) of surviving conelets and cones
on branches of loblolly pine protected with systemic injection
of fipronil or foliar treatments of Asana ® XL,
Magnolia Springs Seed Orchard, Jasper Co., TX.

| | Application | | | |
|---|---|---|---|---|
| | Technique, | | Mean Survival (%) | |
| Treatment | Treatment Date(s) | N | Conelets | Cones |
| Fipronil EC | AJ & SW - Apr. | 8 | 84.9 ± 3.6 b | 65.3 ± 5.0 a |
| 10 ml | | | | |
| Fipronil T | AJ & SW - Apr. | 6 | 71.7 ± 7.2 ab | 63.6 ± 11.2 a |
| 10 ml | | | | |
| Asana ® XL | Hydraulic Foliar | 8 | 82.0 ± 3.3 b | 72.0 ± 4.9 a |
| | 5X | | | |
| Check | | 8 | 63.0 ± 3.8 a | 68.9 ± 4.7 a |

† Means followed by the same letter in each column of the same year are not significantly different at the 5% level based on Fisher's Protected LSD.

TABLE 9
Mean percentages (±SE) of cones killed early and late by coneworms, other-damaged cones,
and healthy cones on loblolly pine protected with systemic injections of fipronil or foliar
treatments of Asana ® XL, Magnolia Springs Seed Orchard, Jasper Co., TX.

| | | | Mean Coneworm Damage (%) | | | | |
|---|---|---|---|---|---|---|---|
| | | | | Late | | | |
| | Application Technique, | | Early | (large dead | | Mean Other | Mean |
| Treatment | Treatment Date(s) | N | (small dead) | and infested) | Total | Damage (%) * | Healthy (%) |
| Fipronil EC 10 ml | AJ & SW - Apr. | 8 | 16.5 ± 3.5 a | 3.0 ± 0.9 a | 19.5 ± 4.2 a | 14.0 ± 3.0 a | 66.5 ± 6.8 a |
| Fipronil T 10 ml | AJ & SW - Apr. | 6 | 26.3 ± 11.2 a | 6.3 ± 1.8 ab | 32.7 ± 12.2 a | 8.9 ± 2.2 a | 58.5 ± 11.9 a |
| Asana ® XL | Hydraulic Foliar 5X | 8 | 16.6 ± 4.1 a | 8.8 ± 2.4 b | 25.4 ± 5.3 a | 11.1 ± 1.9 a | 63.5 ± 6.0 a |
| Check | | 8 | 19.4 ± 4.9 a | 11.2 ± 2.0 b | 30.6 ± 4.6 a | 13.6 ± 2.8 a | 55.8 ± 6.4 a |

* Mortality or wounds caused by drought, pitch canker, squirrel, midge, or mechanical damage.
† Means followed by the same letter in each column of the same year are not significantly different at the 5% level based on Fisher's Protected LSD.

TABLE 10
Seed bug damage, seed extracted, and seed quality (Mean ± SE) from second-year cones of loblolly pine protected with systemic
injections of fipronil or foliar treatments of Asana ® XL, Magnolia Springs Seed Orchard, Jasper Co., TX.

| | | | Mean Seed Bug Damage (%) | | | Mean No. | Mean No. | Mean No. |
|---|---|---|---|---|---|---|---|---|
| | Application Technique, | | Early | | | Seeds | Filled Seed | Empty Seed |
| Treatment | Treatment Date(s) | N | (2nd Yr Abort) | Late | Total | per Cone | per Cone | per Cone |
| Fipronil EC 10 ml | AJ & SW - Apr. | 8 | 4.9 ± 1.5 ab | 15.5 ± 2.9 a | 20.3 ± 3.7 a | 100.8 ± 6.4 a | 77.2 ± 7.5 a | 3.1 ± 0.6 a |
| Fipronil T 10 ml | AJ & SW - Apr. | 6 | 9.2 ± 4.9 b | 12.5 ± 2.6 a | 21.7 ± 5.1 a | 99.3 ± 15.8 a | 75.9 ± 14.8 a | 2.4 ± 0.5 a |
| Asana ® XL | Hydraulic Foliar 5X | 8 | 0.9 ± 0.3 a | 14.3 ± 3.9 a | 15.2 ± 3.9 a | 109.5 ± 10.9 a | 91.4 ± 12.3 a | 3.0 ± 0.6 a |
| Check | | 8 | 4.3 ± 1.4 ab | 16.9 ± 4.4 a | 21.2 ± 4.0 a | 99.6 ± 9.6 a | 76.4 ± 9.8 a | 3.3 ± 0.6 a |

† Means followed by the same letter in each column of the same year are not significantly different at the 5% level based on Fisher's Protected LSD.

TABLE 11
Mean % (±SE) cone and seed losses from insects (coneworms
and seed bugs) and reductions in damage from second-year
cones of loblolly pine protected with systemic injection
of fipronil or foliar treatments of Asana ® XL,
Magnolia Springs Seed Orchard, Jasper Co., TX.

| | Application | | Mean | Mean |
|---|---|---|---|---|
| | Technique & Rate & | | Combined | Reduction |
| Treatment | Treatment Date | N | Losses (%) | (%) |
| Fipronil EC | AJ & SW - Apr. | 8 | 31.5 ± 5.2 a | 23.5 |
| 10 ml | | | | |
| Fipronil T | AJ & SW - Apr. | 6 | 44.0 ± 10.9 a | −7.1 |
| 10 ml | | | | |
| Asana ® XL | Hydraulic Foliar | 8 | 34.4 ± 6.1 a | 16.5 |
| | 5X | | | |
| Check | | 8 | 41.1 ± 4.3 a | |

† Means followed by the same letter in each column of the same year are not significantly different at the 5% level based on Fisher's Protected LSD.

While the invention has been described in detail and with reference to specific embodiments thereof, it will be apparent to one skilled in the art that various changes and modifications can be made without departing from the spirit and scope of the invention.

What is claimed is:

1. A method of reducing damage to a tree caused by insect pests boring into the tree comprising systemically treating the tree with an insecticidally effective amount of an arylpyrazole agent.

2. The method of claim 1, wherein the insect pests are bark beetles.

3. The method of claim 2, wherein the beetles are Dentroctonus spp. or Ips spp.

4. The method of claim 3, wherein the beetles are southern pine beetles.

5. The method of claim 1, wherein the arylpyrazole agent is a compound of the following formula: 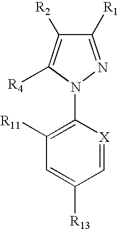
wherein: R₁ is CN or methyl;
R₂ is S(O)ₙR₃;
R₃ is alky or haloalkyl;
R₄ is H, halo, or a radical selected from —NR₅R₆, C(O)OR₇, —S(O)ₘR₇, alkyl, haloalkyl, —OR₈, or —N═C(R₉)(R₁₀);
R₅ and R₆ are independently H, alkyl, haloalkyl, —C(O)alkyl, or —S(O)ᵣCF₃ ; or R₅ and R₆ form together a divalent radical which may be interrupted by one or more heteroatoms;
R₇ is alkyl or haloalkyl;
R₈ is H, alkyl, or haloalkyl;
R₉ is H or alkyl;
R₁₀ is phenyl or heteroaryl, optionally substituted with one or more functional groups selected from hydroxy, halo, —O-alkyl, —S-alkyl, cyano, alkyl or combinations thereof;
X is N or the radical C—R₁₂;
R₁₁ and R₁₂ are, independently, H or halo;
R₁₃ is halo, haloalkyl, haloalkoxy, —S(O)_{q}CF₃ or —SF₅; and
m, n, q, r are independently 0, 1 or 2;
provided that when R₁ is methyl, R₃ is haloalkyl, R₄ is NH₂, R₁₁ is Cl, R₁₃ is CF₃, and X is N.

6. The method of claim 5, wherein R₁ is CN; and/or R₄ is —NR₅ R_{6 ;} and/or R₅ and R₆ are independently H, alkyl, haloalkyl, or —C(O)alkyl, and/or X is C—R₁₂ ; and/or R₁₃ is halo, haloalkyl, haloalkoxy, or —SF₅.

7. The method of claim 5, wherein the arylpyrazole compound is 5-amino-3-cyano-1-(2,6-dichloro-4-trifluoromethylphenyl)-4-trifluoromethylsulfinylpyrazole.

8. The method of claim 3, wherein the arylpyrazole agent is 5-amino-3-cyano-1-(2,6-dichloro-4-trifluoromethylphenyl)-4-trifluoromethylsulfinylpyrazole.

9. The method of claim 1, wherein the arylpyrazole agent is in the form of an emulsifiable concentrate.

10. The method of claim 1, wherein the tree is a deciduous tree.

11. The method of claim 1, wherein the tree is a conifer tree.

12. The method of claim 11, wherein the tree is a loblolly pine tree.

13. The method of claim 1, wherein the arylpyrazole agent is injected into the tree.

14. The method of claim 1, wherein the amount of arylpyrazole agent is less than about one gram active ingredient of arylpyrazole per each inch of tree diameter.

15. A method of controlling insect pests that bore into trees infested with or liable to be infested with insect pests comprising systemically treating one or more of the trees with an arylpyrazole agent in an amount sufficient for effective control of insect pests.

16. The method of claim 15, wherein the insect pests are bark beetles.

17. The method of claim 16, wherein the beetles are Dentroctonus spp. or Ips Spp.

18. The method of claim 17, wherein the beetles are southern pine beetles.

19. The method of claim 15, wherein the arylpyrazole is a compound of the following formula: 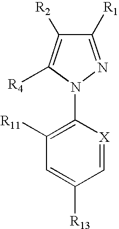
wherein: R₁ is CN or methyl;
R₂ is S(O)ₙR₃;
R₃ is alky or haloalkyl;
R₄ is H, halo, or a radical selected from —NR₅R₆, C(O)OR₇, —S(O)ₘR₇, alkyl, haloalkyl, —OR₈, or —N═C(R₉)(R₁₀);
R₅ and R₆ are independently H, alkyl, haloalkyl, —C(O)alkyl, or —S(O)ᵣCF₃ ; or R₅ and R₆ form together a divalent radical which may be interrupted by one or more heteroatoms;
R₇ is alkyl or haloalkyl;
R₈ is H, alkyl, or haloalkyl;
R₉ is H or alkyl;
R₁₀ is phenyl or heteroaryl, optionally substituted with one or more functional groups selected from hydroxy, halo, —O-alkyl, —S-alkyl, cyano, alkyl or combinations thereof;
X is N or the radical C—R₁₂;
R₁₁ and R₁₂ are, independently, H or halo;
R₁₃ is halo, haloalkyl, haloalkoxy, —S(O)_{q}CF₃ or —SF₅; and
m, n, q, r are independently 0, 1 or 2;
provided that when R₁ is methyl, R₃ is haloalkyl, R₄ is NH₂, R₁₁ is Cl, R₁₃ is CF₃, and X is N.

20. The method of claim 19, wherein R₁ is CN; and/or R₄ is —NR₅R₆; and/or R₅ and R₆ are independently H, alkyl, haloalkyl, or —C(O)alkyl, and/or X is C—R₁₂; and/or R₁₃ is halo, haloalkyl, haloalkoxy, or —SF₅.

21. The method of claim 19, wherein the arylpyrazole compound is 5-amino-3-cyano-1-(2,6-dichloro-4-trifluoromethylphenyl)-4-trifluoromethylsulfinylpyrazole.

22. The method of claim 17, wherein the arylpyrazole agent is 5-amino-3-cyano-1-(2,6-dichloro-4-trifluoromethylphenyl)-4-trifluoromethylsulfinylpyrazole.

23. The method of claim 15, wherein the tree is a deciduous tree.

24. The method of claim 15, wherein the tree is a conifer tree.

25. The method of claim 24, wherein the tree is a loblolly pine tree.

26. The method of claim 15, wherein the arylpyrazole agent is injected into the tree.

27. The method of claim 15, wherein the arylpyrazole agent is in the form of an emulsifiable concentrate.

28. The method of claim 15, wherein the amount of arylpyrazole agent is less than about one gram active ingredient of arylpyrazole per each inch of tree diameter.

29. A method of reducing damage to a tree caused by insect pests boring into the tree comprising systemically treating the tree with an insecticidally effective amount of an aqueous formulation of fipronil.

30. A method of controlling insect pests that bore into trees infested with or liable to be infested with insect pests comprising systemically treating one or more of the trees with an aqueous formulation of fipronil in an amount sufficient for effective control of insect pests.
